(19) United States
(12) Patent Application Publication
(10) Pub. No.: US 2011/0136083 A1
(43) Pub. Date: Jun. 9, 2011

(54) INSTRUCTIONAL TOOL FOR TEACHING SEARCH SKILLS

(75) Inventors: Meredith June Morris, Bellevue, WA (US); Neema Mortazavi Moraveji, San Francisco, CA (US); Daniel Morris, Bellevue, WA (US); Mary Czerwinski, Kirkland, WA (US); Nathalie M. Riche, Seattle, WA (US)

(73) Assignee: Microsoft Corporation, Redmond, WA (US)

(21) Appl. No.: 12/632,813

(22) Filed: Dec. 8, 2009

(51) Int. Cl. G09B 19/00

(52) U.S. Cl. 434/118

(57) ABSTRACT

A method described herein includes receiving, at a first computer, search data from each of a plurality of interconnected client computing devices, wherein the search data comprises one or more search terms provided to one or more search engines by users of the client computing devices, wherein the search data is independent of the search engines utilized by the users of the client computing device. The method also includes causing the search data to be displayed on a display that is in communication with the first computer.

### BACKGROUND

A search engine is a tool that is designed to search for information available on the World Wide Web responsive to receipt of a query. Specifically, the search engine will execute the query over an index of contents of the World Wide Web and provide a ranked list of search results to the user, wherein ideally the most highly ranked results are the most relevant to the informational goals of the user.

Content available by way of the World Wide Web, however, is incredibly dynamic. Thus, a search query proffered today that provides relevant results to the user may provide entirely different results if issued a month later to the same search engine. Furthermore, search engines are often updated to provide functionality that has not been previously associated with search engines. For example, some search engines are configured with functionality that causes an answer to be returned responsive to receipt of a query (rather than a list of URLs provided responsive to receipt of a query). For instance, if a user issued the query “What is the capital of the United States?” the search engine may be configured to return the answer “Washington, D.C.” rather than a link to a website that includes the answer to such questions. Additionally, some search engines are configured to search for travel information such that an individual may purchase plane tickets through the search engine.

In the academic community as well as in the private sector, quickly locating information via a search engine is desirable. For instance, an academic writing a paper may wish to search for information pertaining to the topic of the paper and be provided with such information via a search engine. In a competitive business setting, a person or company may wish to search for rates being charged for services by competitors. Conventionally, learning how to use a search engine is undertaken via online tutorials provided by the search engine or through a trial and error approach.

### SUMMARY

The following is a brief summary of subject matter that is described in greater detail herein. This summary is not intended to be limiting as to the scope of the claims.

Described herein are various technologies pertaining to a tool that is designed to support search skill instruction in a classroom setting. A plurality of computing devices that are configured to be utilized by students in a classroom environment (client computing devices) can be equipped with an Internet browser. The plurality of computing devices may also be configured with a tool that causes activities of the students to be forwarded to a computer (server computing device) that is operated by an instructor/teacher. Specifically, search activities undertaken by way of the browser on the computing devices operated by the students can be recorded and forwarded to the computing device that is operated by the instructor/teacher. These actions can be or include the proffering of a query to a search engine, a visitation to a web page, a copying and pasting of text on a web page, an amount of time spent by students on certain web pages, an amount of time a student hovers over certain text in a web page, amongst other actions that a student may undertake while browsing. The client computing devices can be configured to transmit these actions in real-time to the computing device operated by the teacher.

A client computing device can also be configured to display a search history on the display screen of the computing device, wherein the search history includes search and browsing history regardless of a search engine utilized by the student to perform the search. For instance, the student may perform a first search using a first search engine, a second search using a second search engine, etc. Additionally, the user may select search results (web pages) provided by different search engines. The search history can be displayed on the display screen of the client computing device such that if the instructor walks by the display screen, the instructor can quickly ascertain search strategies of the student, including queries issued, search engines utilized, etc. Additionally, the student can use the search history to return to a previous search, to review activities of the search, etc.

The instructor may have access to a display that is only visible to such instructor. The instructional search tool described herein can cause the display of the instructor to display information pertinent to the activities of the students being taught by the instructor. For example, the task may be to locate certain information that is available by the World Wide Web and the students in the classroom may begin using search techniques in an attempt to locate such information. These techniques may be displayed on the display screen that is visible to the instructor. For example queries issued by students, web pages visited by students, etc. may be visible to the instructor on the display screen.

Additionally, another display screen may be visible to the entirety of the classroom. This display screen may display search strategies undertaken by students, wherein such strategies may be helpful for the students in forming their own searches or seeing how others are approaching a similar problem. This navigational information may be represented in a variety of ways. For instance, query terms that are often utilized by many students in the classroom may be highlighted on the display screen that is visible to the class. Furthermore, in another example, a web page that is visited often can be represented in such a way that students in the class can ascertain that other students have selected such web page. For instance, a URL can be placed in a particular font or size to indicate to the class that such web page is popular amongst other students in the class for a certain search task.

Other aspects will be appreciated upon reading and understanding the attached figures and description.

### BRIEF DESCRIPTION OF THE DRAWINGS

FIG. 1 is a functional block diagram of an example system that facilitates utilization of an instructional search tool in a classroom setting.

FIG. 2 is an example graphical user interface that can be presented to an instructor.

FIG. 3 is an example graphical user interface that facilitates displaying queries issued by students in a classroom setting to an instructor or an entirety of a class.

FIG. 4 is an example graphical interface that depicts search terms utilized by students for a search task in a classroom setting.

FIG. 5 is an example graphical user interface that depicts search queries and/or search terms utilized by students to perform a search task in a classroom setting.

FIG. 6 is an example graphical user interface that presents web pages or domains selected by students that are performing a search task in a classroom setting.

FIG. 7 is an example graphical user interface that depicts domains selected by students performing a search task in a classroom setting.

FIG. 8 is an example graphical user interface that illustrates domains and/or sites selected by students performing a search task in a classroom setting.

FIG. 9 is a graphical user interface that depicts overall search strategies utilized by students in a classroom to an instructor.

FIG. 10 is an example graphical user interface that depicts particular navigational activities of a student in a classroom setting.

FIG. 11 is an example graphical user interface that can be displayed on a computing device of a student.

FIG. 12 is flow diagram that illustrates an example methodology for displaying navigational data on a display screen of an instructor.

FIG. 13 is a flow diagram that illustrates an example methodology for displaying search history on a computing device in a classroom setting.

FIG. 14 is an example computing device.

### DETAILED DESCRIPTION

Various technologies pertaining to search engines in general, and an instruction tool for search engines in particular, will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

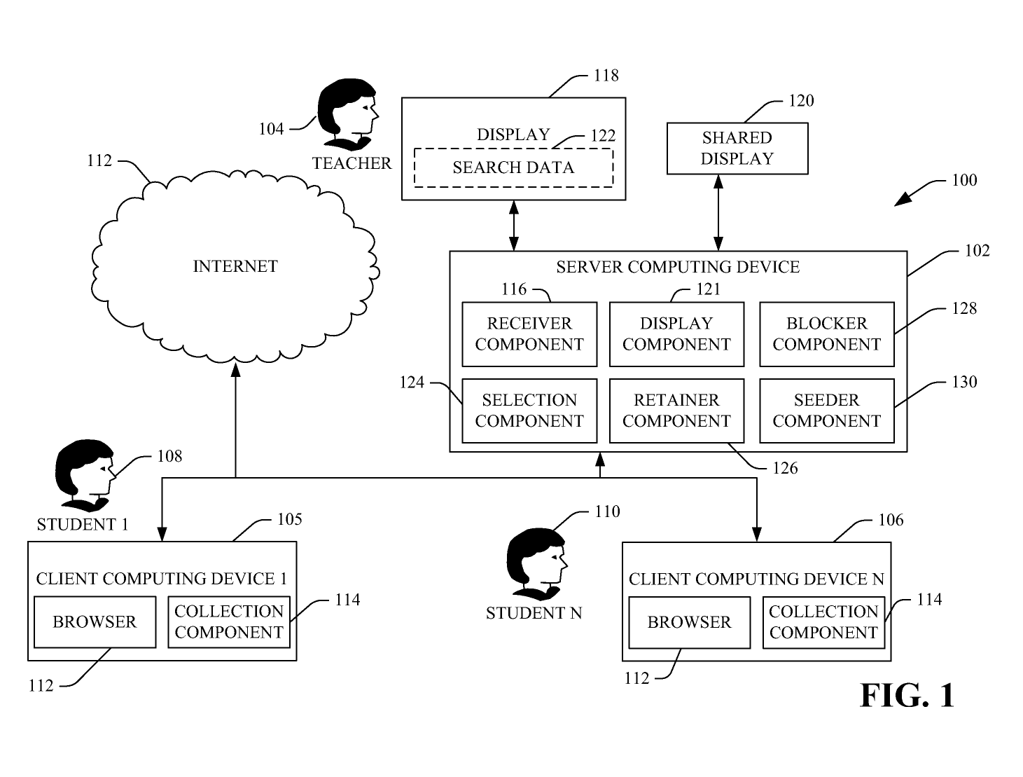

With reference to FIG. 1, an example system 100 that facilitates providing instructions pertaining to the utilization of one or more search engines is illustrated. The system 100 includes a server computing device 102 that is operated by a teacher/instructor 104 in a classroom setting. The classroom setting may be a single room or may be a distributed classroom setting where instruction is given, for example, over the Internet. A plurality of client computing devices 105-106 are in communication with the server computing device 102. For example, the client computing devices 105-106 may be interconnected with the server computing device 102 over a local area network (LAN). The client computing devices 105-106 are operated by students 108 and 110, respectively. Furthermore, the server computing device 102 and the client computing devices 105-106 may be connected to the Internet 112 such that search tasks can be performed through utilization of one or more search engines. The server computing device 102 and the client computing devices 104-105 can be any suitable computing devices, including desktop computing devices, laptop computing devices, smart phones, etc.

Each of the client computing devices 105-106 can be configured with an Internet browser 112. The Internet browser 112 can be utilized by the students 108-110 to perform search tasks to locate information available on the Internet 112. For example, the student 108 can utilize the browser 112 and type in a URL into a field of the browser 112 to cause the browser to load a particular web page associated with the URL. In another example, the browser 112 can be directed to a search engine and the student 108 can proffer a query to the search engine which may then return a plurality of search results pertaining to the query. The student 108 may select one or more of the search results to cause the browser to load a web page corresponding to the selected search result. The student 108 may copy and paste text from one or more web pages or perform other actions that can be undertaken through utilization of the browser 112.

The client computing devices 105-106 can also each be configured with a collection component 114 that is operative to collect navigational activities (search data) of the students 108-110 and cause such navigational activities to be transmitted to the server device 102 that is operated by the teacher 104. The navigational activities that can be collected by the collection component 114 at each client computing device 105-106 can include, but are not limited to, queries submitted by the students 108-110, search engines utilized when submitting the queries, pages visited upon receiving search results provided by search engines, in-page events such as highlighting text, copying text, scrolling over the web page, an amount of time spent viewing certain web pages, an amount of time utilized to craft a query, an amount of time between crafting queries, a number of web pages visited for a particular query, as well as outside of browser events such as pasting text into a word processing application, opening a different application, etc. It is to be understood that the collection component 114 collects and transmits navigational activities of the students 108-110 independent of the search engine utilized by the students 108-110. For instance, the student 108 may utilize a first search engine to execute a first query and then may utilize a second search engine to execute a second query. The collection component 114 can collect these activities and transmit the activities to the server computing device 102 utilized by the teacher 104.

While not shown, each of the client computing devices 105-106 includes a display that displays web pages that are being viewed by the students 108-110 to the students 108-110. These displays may also display search history of the students. The search history may include queries submitted by the students, web pages visited responsive to execution of the queries, identities of search engines utilized to execute the queries, amongst other search history. Thus, the teacher 104 may walk past a computing device utilized by a student and can ascertain the status of search task assigned to the student and how they chose to perform such task. The teacher 104 may then be able to provide suggestions to the student 108 as to how to better perform the search or different queries that the student 108 may think about proffering to one or more search engines.

In addition to displaying search history, the display of the client computing devices 105-106 can be utilized to display class-wide visualizations of search tasks performed by students in the class. This may be particularly effective if the students 108-110 do not have visual access to a common display (e.g., if the students are remote). Such class-wide representations may include queries submitted by other students in the class, web pages visited by other students in the class, time spent on certain web pages, most popular web pages, most popular queries or query terms amongst other information. Some of this data may be presented to the students 108-110 as links that can be selected by such students 108-110. Selection of a link can cause a browser 112 on the computing devices 108-110 to load the web page corresponding to the link. Alternatively, class-wide navigational data can be provided to a particular student to aid in stimulating search ideas for the student with respect to a certain task.

In still yet another example, a task-specific graphical user interface can be displayed to students on the client computing devices 104-106. This task-specific graphical user interface may include a search task that is to be performed by the student (e.g., locate information “X”). The task-specific graphical user interface may include buttons or fields that students can utilize to provide answers to questions pertaining to the search task to cause data to be transmitted to the server computing device 102 operated by the teacher 104.

As indicated above, the server computing device 102 can receive navigational activity undertaken by the students 108-110 on the client computing devices 105-106. Specifically, the server computing device 102 can include a receiver component 116 that is operative to receive the navigational data (search data) from the plurality of client computing devices 105-106. The search data includes queries provided to a plurality of search engines by the students 108-110 of the client computing devices 105-106, wherein the search data is independent of the search engines employed by the students to perform searches. For example, the receiver component 116 may be a portion of memory in the server computing device 102, a port or other suitable component.

A display 118 is in operative connection with the server computing device 102, and the display 118 may be visible only to the teacher 104 (and not the students 108-110). A shared display 120 may also be in operative communication with the server computing device 102, wherein the shared display 120 is configured to display data to the students 108-110 and the teacher 104. For example, the shared display 120 may be a large LCD display, may be a projected display, or other suitable display.

The server computing device 102 further includes a display component 121 that is operative to cause search data 122 received by the receiver component 116 to be displayed on the display 118 and/or the shared display 120. As will be described below, the search data 122 received from the client computing devices 105-106 can be displayed in a variety of formats, wherein a format may be selected by the teacher 104 and such format may be different on the display 118 when compared with the search data on the shared display 120. Moreover, as the search data 122 is received from the client computing devices 105-106 in real-time, the display component 121 can cause the display of the search data 122 on the display 118 or the shared display 120 to be dynamically updated as such data is received from the client computing devices 105-106.

The server computing device 102 may further comprise a selection component 124 that can receive a selection of at least a portion of the search data 122 displayed on one or more of the displays 118 or 120. The selection can be made by the teacher 104 that is using the server computing device 102. Selection of such portion of the search data 122 can cause additional data pertaining to the selected portion of the search data to be displayed on the display 118 and/or the shared display 120. For example, if the search data 122 includes a list of queries proffered by the students 108-110 to perform a search task, the teacher 104 can select one such query. Upon selection of the query, for instance, identities of students that proffered the query can be displayed to the teacher 104 on one or more of the displays 118 or 120. Additionally or alternatively, upon selection of a query, websites visited responsive to proffering the query can be displayed to the teacher 104 on the display 118 and/or shared to all on the shared display 120. Examples of types of data that can be displayed will be provided below.

The server computing device 102 can further include a retainer component 126 that can cause a report to be retained, wherein the report pertains to tasks performed by the students 108-110. For instance, such reports may include queries issued by the students 108-110, web pages visited by the students, amount of time spent on web pages visited by the students amongst other data. Such reports may be useful when a search task needs several hours to complete but an amount of time per class is limited to less than the time required to complete the task. Thus, the retained report can be used to inform the students of the current status of their search task. In another example, the search report retained by the retainer component 126 can be informative to others that are performing a similar search task or an analogous search task. Furthermore, the retained report can be utilized to re-load the state of the search task. For instance, the server computing device 102 can load the report, which can cause the client computing devices 105-106 to return to a state in the search task at the time the report was saved, and can further cause the server computing device 102 to return to the state in the search task at the time the report was saved.

As indicated above, the search data 122 that is displayed on the display 118 and/or the display 120 can include a variety of information pertaining to a search task that is undertaken by the students 108-110 under supervision of the teacher 104. For example, the search data 122 may include representations of individual students, wherein such representations can indicate identities of web pages visited by the students, identities of queries issued by the students, a number of web pages visited by the students, a number of queries proffered by the students, particular “answers” that are located by the students (if there is a task where answers are required), amongst other data pertaining to individual students. Additionally or alternatively, the search data 122 displayed on the display 118 and/or the shared display 120 can be or include aggregate representations of an entirety of a class. For instance, this representation may include data pertaining to what queries the class executed, what sites the students in the class visited, answers that students in the class returned, amount of time on certain websites, most popular websites, most popular search terms or queries, amongst other data.

Furthermore, the search data 122 that is displayed on the display 118 may be different than search data displayed on the shared display 120. In another example, the search data 122 displayed on the display 118 may be identical to that displayed on the shared display 120. For instance, contents of the shared display 120 may be customized by the teacher 104 such that the information depicted to the students 108-110 is as intended by the teacher 104. In another example, the search data 122 on the shared display 120 may be in anonymized version of the search data 122 that is displayed to the teacher 104 on the display 118.

While the description of the system 100 above has described communications flowing from the client computing devices 105-106 to the server computing device 102, it is to be understood that the teacher 104 may cause the server computing device 102 to transmit data the client computing devices 105-106. In an example, the server computing device 102 may comprise a blocker component 128, which can be configured to block one or more students from undertaking further activity using browsers on one or more of the client computing devices 105-106. This tool can be employed to retain attention of students and/or to keep students on task.

The server computing device 102 may also comprise a seeder component 130 that can cause data to be transmitted to one or more of the client computing devices 105-106 that causes browsers on such computing devices 105-106 to execute a particular query. This can be used in connection with lessons that desirably focus on analyzing/assessing search results separately from query formulation. Other actions that may be undertaken from the server computing device 102 include clearing search histories of students (when it is desirable to start a new task) as well as profanity filtering. For example, search data displayed to the classroom is desirably free of profanity, and the server computing device 102 may comprise a profanity filter that filters profanity to prevent such profanity from being displayed to the class. Additionally, the teacher 104 may manually remove a term (in a query, in a search result, etc.) with a single click, for example, such that search data displayed to the classroom is in a form desired by the teacher 104.

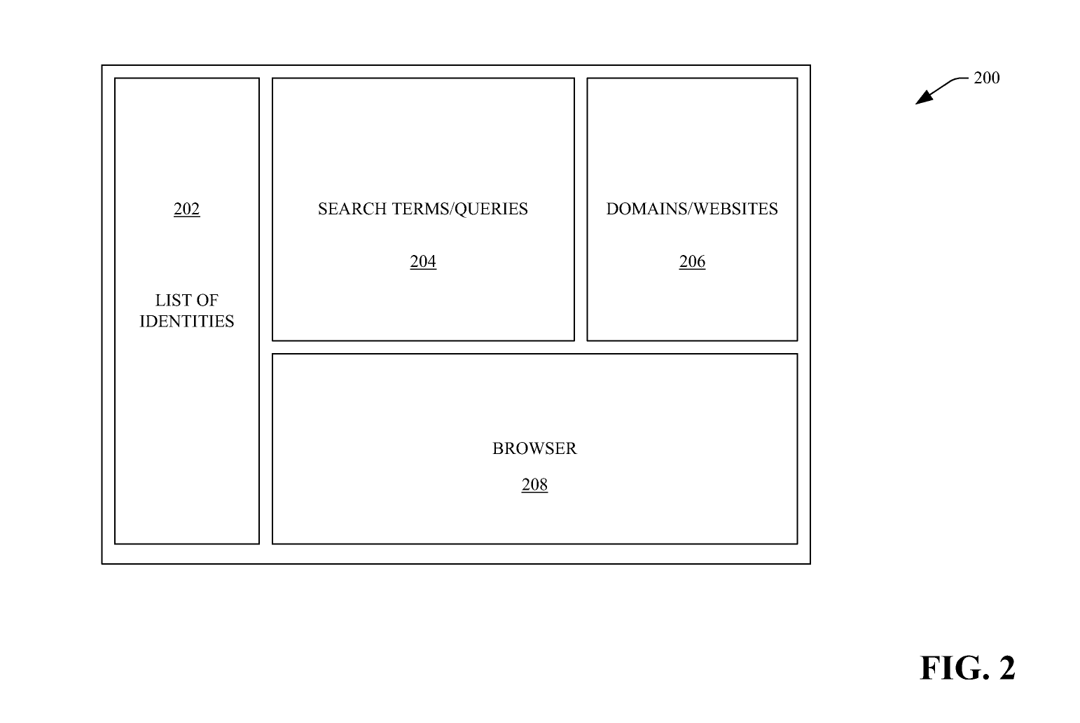

With reference now to FIG. 2, an example graphical user interface 200 that can be displayed on a display 118 (FIG. 1) that is only viewable by the teacher 104 and/or displayed on the shared display 120 which can be viewed by the entire classroom is illustrated. While the graphical user interface 200 is shown as including a plurality of different portions, it is to be understood that a graphical user interface may include a subset of such portions or additional information not shown as being included in the graphical user interface 200. The graphical user interface 200 includes a first portion 202 that can display a list of identities of students that are being instructed in the classroom. The students listed in such list of identities can be selectable by, for example, voice command, a touch sensitive display or another input device such as a computer mouse. Upon selection of an individual student from the list of identities, additional information pertaining to such student can be displayed including, but not limited to, queries set forth by the student, search strategies undertaken by the student, websites visited by the student, text copied and pasted from web pages by the student, amount of time spent on certain web pages or formulating queries, etc.

The graphical user interface 200 may include a second portion 204 that depicts search terms and/or search queries utilized by the entirety of the classroom or by a particular student selected from the list of identities displayed in the first portion 202 of the graphical user interface 200. As will be described below, search terms and/or queries can be displayed in a variety of formats. For instance, search terms and/or queries can be displayed in a list format, may be displayed such that a viewer of the search term/query can ascertain how often a search term or query was issued by students in the classroom, etc.

The graphical user interface 200 may further include a third portion 206 that displays domains and/or particular websites visited by one or more students in the classroom upon issuing one or more of the search terms/queries displayed in the second portion 204 of the graphical user interface 200. The domain/websites can be displayed to the teacher 104 and/or the student via the display 118 and/or the shared display 120 in any suitable format. For instance, the domain/website in the third portion 206 of the graphical user interface 200 can be displayed in a tree structure such that the teacher can quickly ascertain which domains were visited by students and which websites in such domains were visited by the students. In another example, the domain/website can be displayed in a manner that indicates the popularity of such domains/websites amongst students listed in the first portion 202 of the graphical user interface 200. Other manners for displaying domain/websites visited by students in the list of identities are contemplated and are intended to fall under the scope of the hereto-appended claims.

The graphical user interface 200 may also include a fourth portion 208 that displays a browser. Thus, the teacher 104 can browse websites by entering URLs into a particular field of the browser. In another example, the teacher 104 can initiate a search by selecting one or more of the search terms/queries displayed in the second field 204. For instance, a browser may be automatically directed to a search engine utilized by a student who has submitted a search term/query. Furthermore, the browser may be directed to a particular domain/website upon the teacher 104 selecting a domain/website depicted in the third portion 206 of the graphical user interface 200. The browser allows the teacher 104 to supervise activities of the students in the classroom and also allows the teacher 104 to independently perform a certain task assigned to the class.

As described above, contents of the graphical user interface 200 may be updated in real-time as students provide search data or alter their search strategies. Thus, if a student proffers a new query to a search engine, the second portion 204 of the graphical user interface 200 can be updated to reflect the new query issued by the student. Further, if the student then selects a domain/website upon executing the query, the third portion 206 can be updated to include or emphasize the selected domain/website.

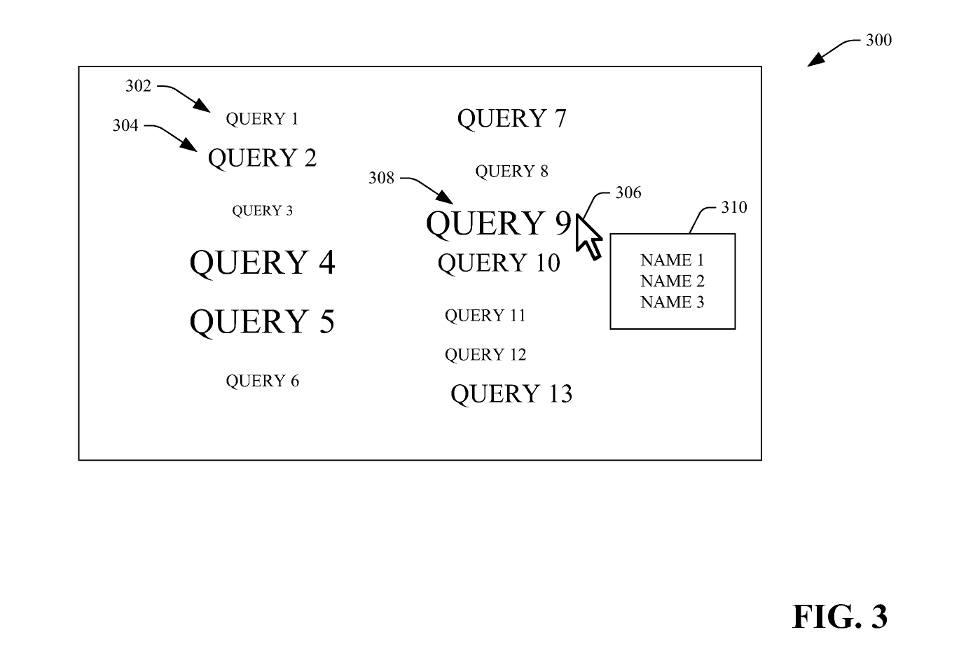

With reference now to FIG. 3, an example graphical user interface 300 that facilitates displaying queries issued by students in the classroom to the teacher 104 or to each of the students on the shared display 120 (or pushed to the students' computers so that they can view how others are performing a search task), is illustrated. The graphical user interface 300 includes a cloud-like view of queries that are utilized by students to locate information. The queries can be arranged, for instance, based upon the recency of issuance of the queries. Thus, a first query 302 may be issued most recently by a student while a second query 304 was issued previously by the students or a different student. Furthermore, the queries can be displayed such that they are indicative of popularity among students. Thus, the first query 302 is not as popular as the second query 304. For example, this can be indicated by font of the displayed query, size of the displayed query (as shown), color of the displayed query, or other suitable manner of indicating a popularity of such query to the teacher 104 or students in the classroom.

Queries depicted in the graphical user interface 300 may be presented as hyperlinks such that they are selectable by a student or the teacher 104. Selection of a query can cause a search engine to execute the query such that search results pertaining to the query can be viewed in a browser. The search engine used to utilize the query may be the search engine most recently used to execute the query, a search engine most often used to execute the query, or a default search engine. Alternatively or additionally, selection of the query can cause a web browser to load each search engine utilized to execute the query and cause such search engines to execute the query so that the teacher 104 and/or the students in the classroom can view how different search engines execute a substantially similar query.

In another example, the queries may be hovered over by the teacher 104 or the students. As shown, a mouse pointer is hovering over a ninth query 308. Upon performing such hovering over such 9th query 308, an inline popup 310 can be displayed on the graphical user interface 300, wherein the inline popup 310 includes a list of identities that executed such query. Inline popup 310 may provide additional information to give the teacher 104 some idea of context of a search task when a query was executed. For instance, the inline popup 310 may also include a time that the query was issued by a particular student, identities of queries executed previously or subsequently to executing the selected query, one or more web pages visited upon the query being executed, etc.

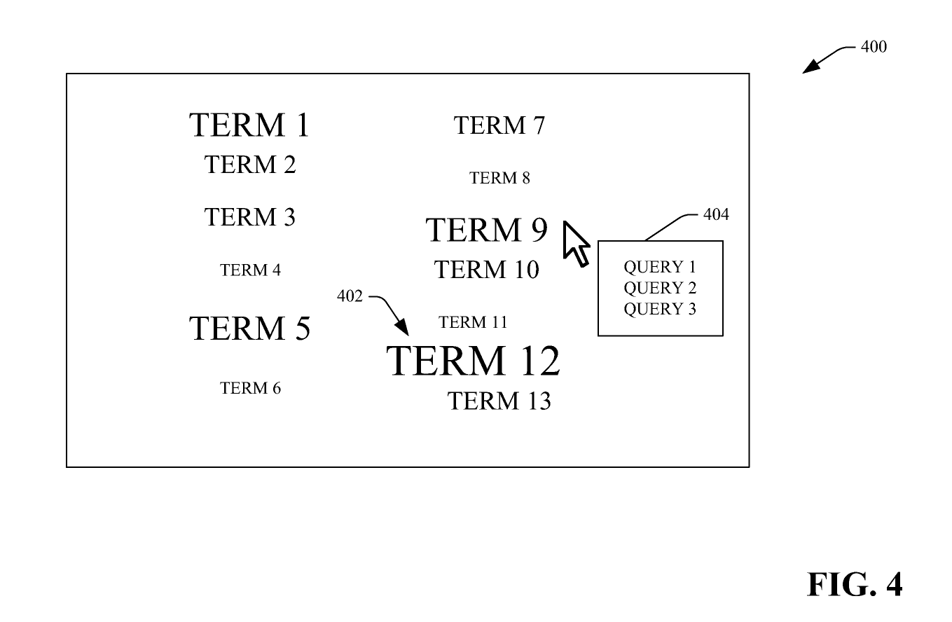

With reference now to FIG. 4, a graphical user interface 400 that displays terms in search queries issued by students in the classroom is illustrated. The graphical user interface 400 is similar to the graphical user interface 300 shown and described in FIG. 3. However, rather than depicting entireties of queries, the graphical user interface 400 can display individual terms in queries issued by students in the classroom. Such terms displayed in the graphical user interface 400 may be displayed in a cloud format such as that shown in the graphical user interface 300 of FIG. 3. The terms can be arranged or displayed in any suitable manner. For instance, the terms can be made bold or larger if they are included in several queries compared to other queries. Thus, for example, a twelfth term 402 may be a most popular term in queries issued by students. The terms displayed in the graphical user interface 400 may be selectable wherein, for instance, selection of a term causes one or more queries that utilize such terms to be executed by one or more search engines. In another example, selection or hovering over a term can cause an inline popup 404 to be displayed in the graphical user interface 400, wherein the inline popup, for instance, may include a list of queries submitted by students that include the term. Also, additional information pertaining to the term can be displayed such as when the term was issued, identities of students that included the term in one or more queries, whether a same student used the term multiple times in different queries, etc.

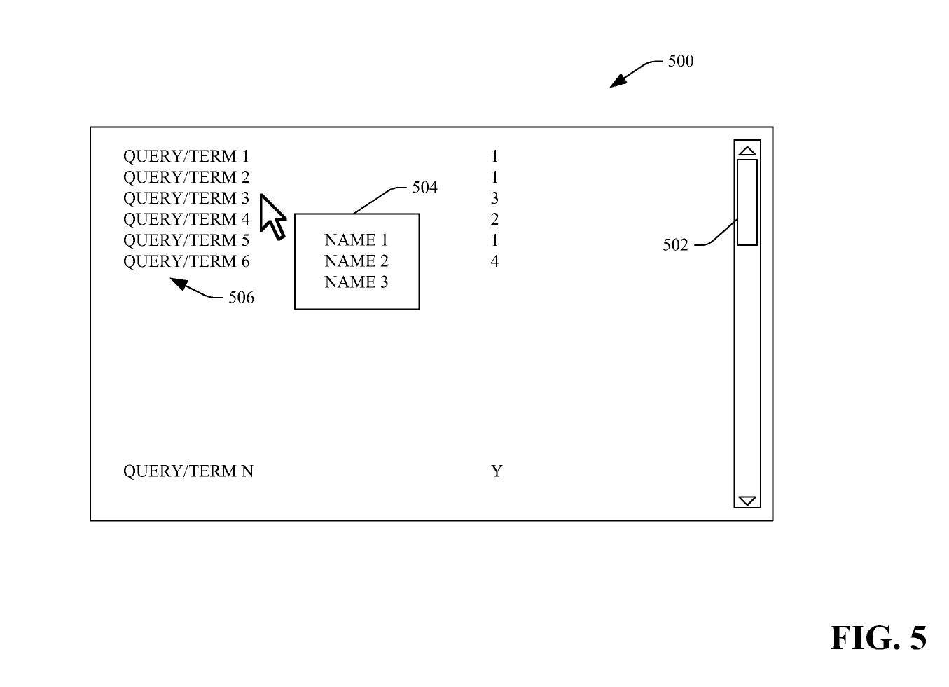

Turning now to FIG. 5, another graphical user interface 500 for representing queries and/or terms issued by students in a classroom environment to perform a search task is illustrated. In this example, the queries/terms can be presented in list format, wherein a scroll bar 502 can be utilized to scroll through the list of queries/terms utilized by students in the classroom to perform the search task. Again, the queries and/or terms can be selectable by the teacher 104 such that selection of the query and/or term causes a search engine to execute the query and/or a query that includes the term. This allows the teacher 104 to see which search results were presented to students that issued the selected query and/or term. In another example, selecting or hovering over a query and/or term can cause an inline popup 504 to be displayed in the graphical user interface 500. The inline popup 504, as shown, can display names of students that issued the query. Additionally, the inline popup 504 may include other information pertaining to the query such as when the query was issued, when the term was issued, what other terms were included in the query, what queries were issued prior to or subsequent to the selected query being issued by a certain student, amongst other information. Furthermore, in the list of queries, a number of times that the query/term was issued can be presented in the graphical user interface 500. Thus, for instance, as can be ascertained, a sixth query/term 506 was issued four times by students in the classroom.

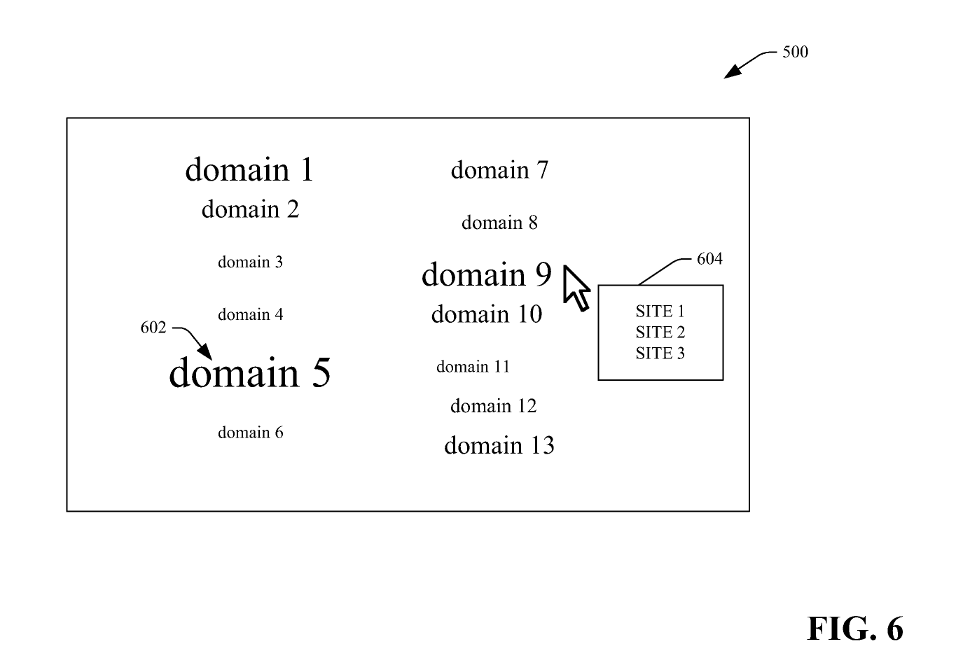

With reference now to FIG. 6, a graphical user interface 600 that facilitates displaying domains visited by students in a classroom setting is illustrated. The graphical user interface 600 displays a plurality of domains, wherein such domains are visited by students when performing a search task in a classroom setting. As with the query/terms described above, the domains can be displayed such that popularity of the domains can be ascertained, recency of visitation to a domain can be ascertained, etc. For instance a fifth domain 602 may be a most popular domain as it is displayed in a larger size than other domains. Additionally, colors assigned to domains, placement of domains in a cloud of domain names, etc. may be indicative of certain parameters pertaining to the domain such as popularity, time spent by students in the domain, etc. Each of the domains may be selectable, wherein selection of the domain causes a web browser to load a web page pertaining to the domain. Additionally or alternatively, selection or hovering over a particular domain can cause an inline popup 604 to be displayed in the graphical user interface 600. For example, the inline popup 604 can display websites visited by students in the classroom that are included in the selected domain. Of course, other information may also be included in the inline popup 604 such as identities of students that visited the domain, time that the domain was visited by certain students, a number of times that certain sites were visited in the select domain, etc.

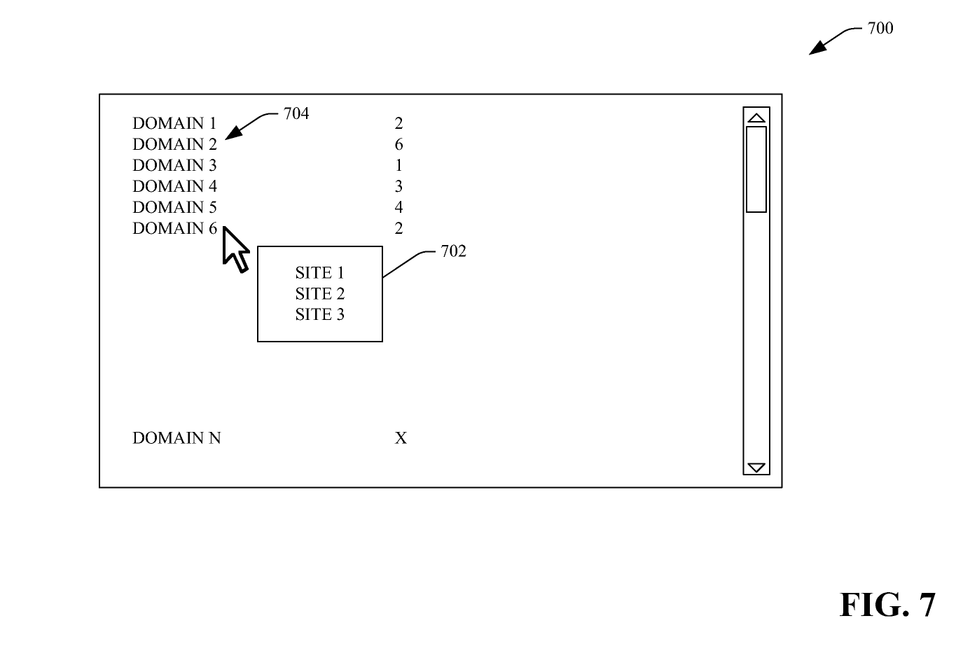

Turning now to FIG. 7, an example graphical user interface 700 that facilitates display of domains visited by students in a classroom when performing a search task is illustrated. In this example, the domains visited by the students are displayed in a list format. Selection of a domain may cause a browser to load a web page corresponding to such domains. In another example, selection of or hovering over a domain may cause an inline popup 702 to be displayed, where the inline popup 702 may include sites visited by students in the selected domain. Other information may also be included in the inline popup 702 including, but not limited to, identities of students that visited the domain, times that the domains were visited by students, domains previously visited by students, queries executed to locate the selected domain, etc. Each of the domains may have a number corresponding thereto that indicates a number of students that visited the domains. Thus, as can be discerned, a second domain 704 has been most popular for this particular search task. The viewer of the graphical user interface 700 (the teacher) may utilize a scroll bar 706 to scroll through the list of domains.

Domains in the list of domains may be ordered in any suitable manner. For instance, the domains may be ordered alphabetically, based upon time that the domains were visited (e.g., most recent domains listed first), based upon popularity, etc.

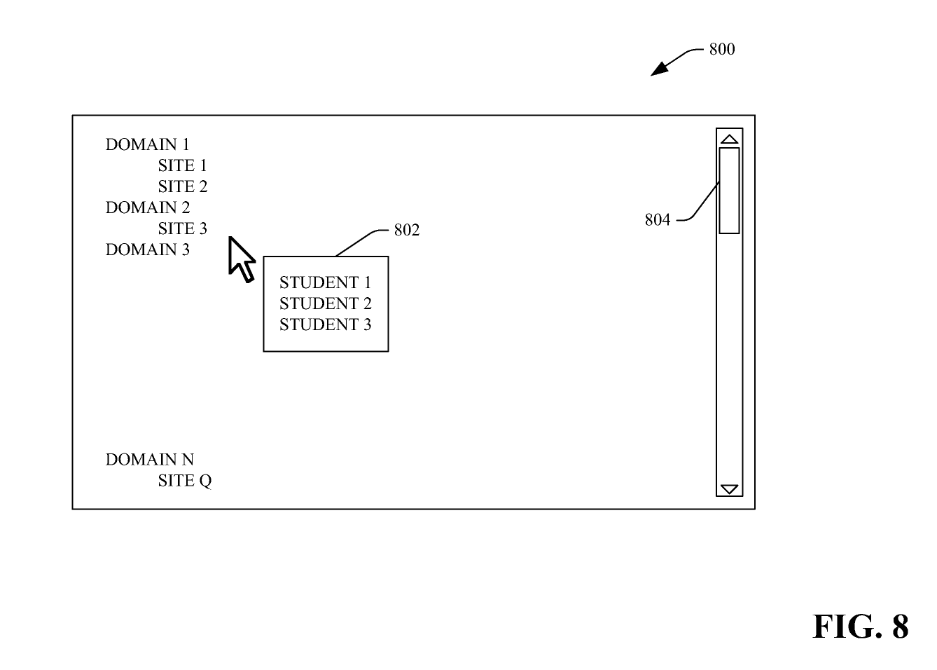

Turning now to FIG. 8, an example graphical user interface 800 that can be utilized to depict domains and sites visited by students in a classroom environment when performing a search task is illustrated. The graphical user interface 800 can display domains and corresponding sites in a tree-like structure. Thus, a domain can be presented as a branch and websites corresponding to such domain can be depicted as sub branches of the branch. As shown, a first domain was accessed by at least one student in the class and first and second sites in the first domain were accessed. The graphical user interface 800 can list a plurality of such domains in the tree-like structure. The domains and/or sites can be selectable such that selection of a domain or site can cause a browser to load such domain/site. Additionally or alternatively, selection of a domain or site may cause an inline popup 802 to be presented in the graphical user interface 800, wherein the inline popup 802 comprises additional information pertaining to the selected domain/site. This information may include identities of students that accessed the selected domain/site, times corresponding to such access, queries utilized to access the domain/site, search engines used to access the domain/site, etc. A slide bar 804 can be utilized to navigate the list of domains/sites.

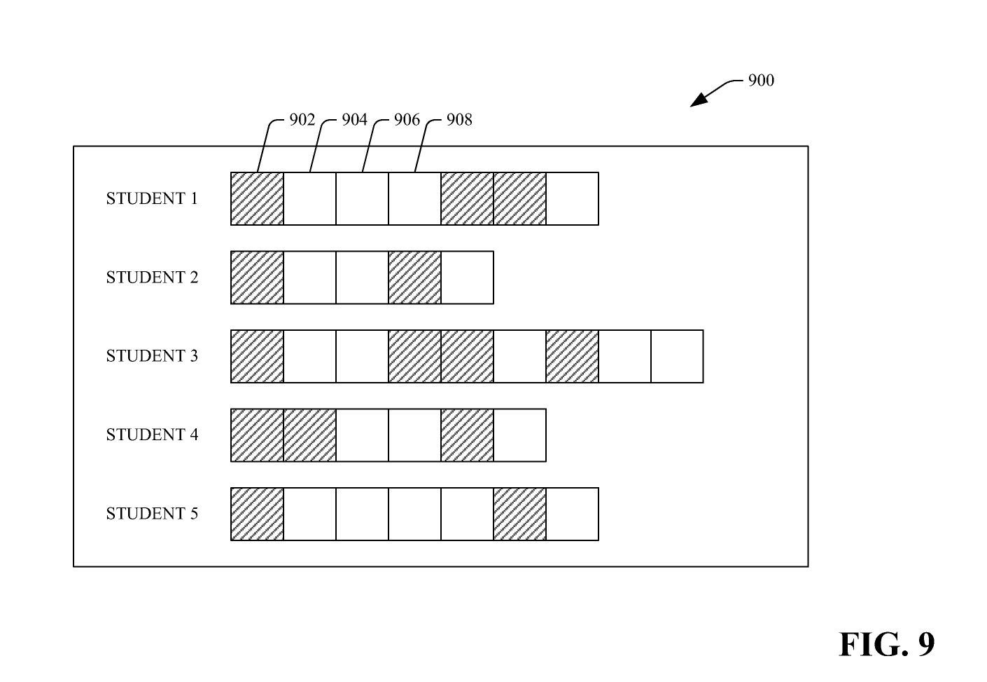

Now referring to FIG. 9, an example graphical user interface 900 that depicts an overall representation of search strategies undertaken by students in the classroom is illustrated. The graphical user interface 900 includes a list of students in the class. In this example graphical user interface 900 each student has a plurality of blocks corresponding thereto. Shaded blocks indicate that the student issued a query while clear blocks indicate that the student visited websites. For example, a first student initially provided a search engine with a query. Thereafter, the first student selected three websites prior to providing the search engine (or a different search engine) with another query. The search results returned to the student responsive to the student issuing the second query may have been suboptimal as the student immediately issued another query without selecting a website.

Thereafter, the first student selected a website. By selecting one of such blocks, information pertaining to the action undertaken by the student can be displayed to the teacher, for instance. In an example, selection of block 902 corresponding to the first student can cause information pertaining to the query issued by the first student to be displayed to the teacher. This information may include the query issued, the search engine utilized, amongst other information. If the teacher wishes to view websites selected by the student upon issuing the first query, the teacher can select the block 904, 906 and/or 908. Upon selection of one of those blocks, data pertaining to the website selected by the student can be displayed to the teacher. This data can include, but is not limited to, a URL pertaining to the website, an amount of time spent on the website by the student, data that is copied from the website, amongst other information. Additionally or alternatively, selection of one of the blocks 904 through 908 can cause a browser on the computing device of the teacher to load such website so that the teacher can review contents of the website.

Of course, other mechanisms can be employed in connection with the graphical user interface 900 to illustrate activities of students with respect to a search task. For example, in addition to using different colors for blocks to illustrate queries and websites, different saturation of colors can be employed to indicate an amount of time a particular student spent on a certain web page or search results page. For example, if a green block is utilized to indicate a web page, then different colors of green may indicate how long the person dwelled on that particular page. Tooltips can also be displayed over one or more blocks, and hovering over a block can cause data to be presented such as title of a page, an amount of time spent on a web page by a student, text highlighted or extracted from the web page by the student, etc.

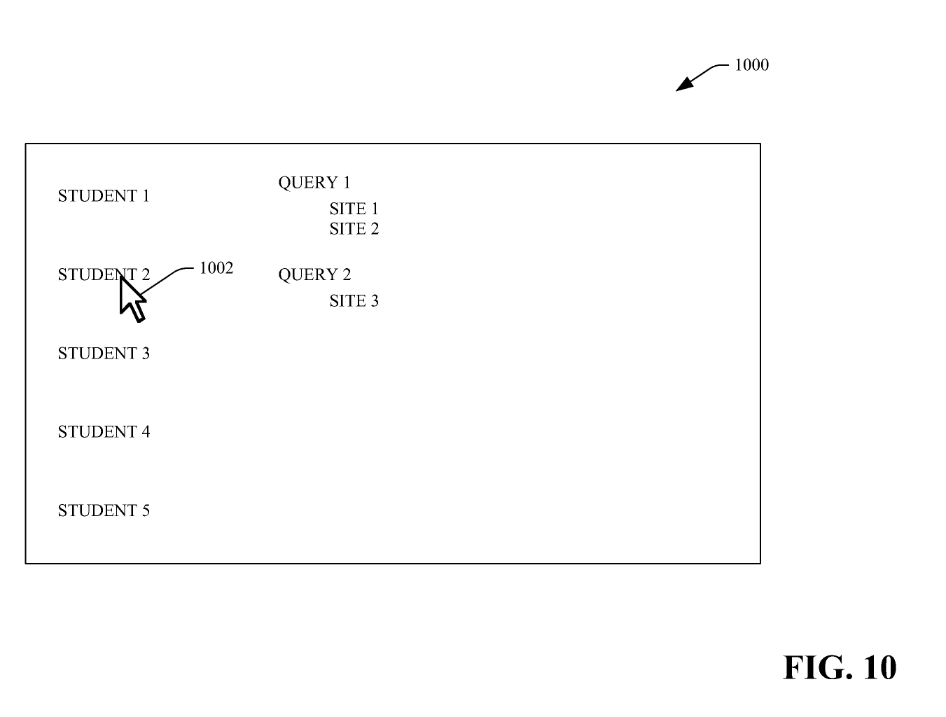

With reference now to FIG. 10, another example graphical user interface 1000 that can be utilized to provide information pertaining to search activities undertaken by students in the classroom setting is illustrated. The graphical user interface 1000 displays a list of students in the classroom. Selection of one of such students from the list of students by way of a mouse pointer 1002 for instance, can cause details pertaining to search activities of the student to be displayed in the graphical user interface 1000. As shown, the mouse pointer 1002 is utilized to select a second student. Upon selection thereof, information pertaining to search activities of the second student can be displayed in the graphical user interface 1000 including, but not limited to, queries issued by the student, sites visited by the student, an amount of time that the student spent viewing particular sites, a sequence of queries and sites, data that was copied from such sites, etc.

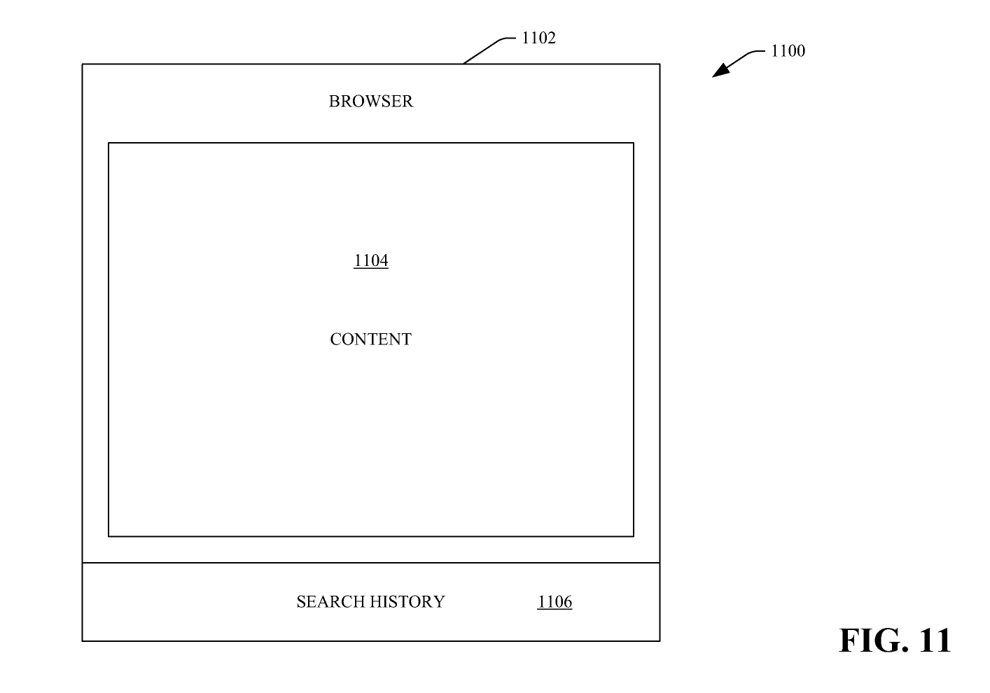

Now referring to FIG. 11, a graphical user interface 1100 that can be displayed on a display screen of a computing device utilized by a student is illustrated. The graphical user interface 1100 includes an Internet browser 1102 that can be utilized by the students to access one or more websites, including search engines. The browser has a field 1104 that shows content of web pages to the students. The browser 1102 may also be configured with buttons and the like, such as is known in the art. A search history portion 1106 can display search history of the students together with the browser 1102. Therefore, if the teacher walks past the display screen of the student, the teacher can quickly ascertain from viewing the search history 1106 what strategy of search has been undertaken by the student. The search history 1106 may include queries entered by the student, identities of search engines utilized by the student, websites visited by the student, an amount of time on websites viewed by the student, amongst other information.

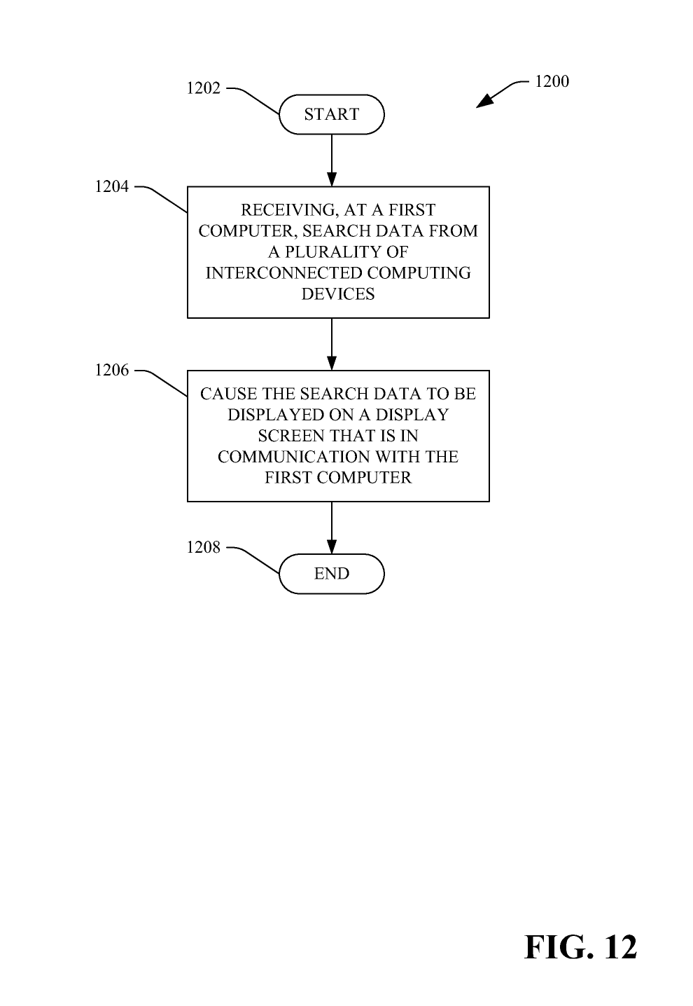

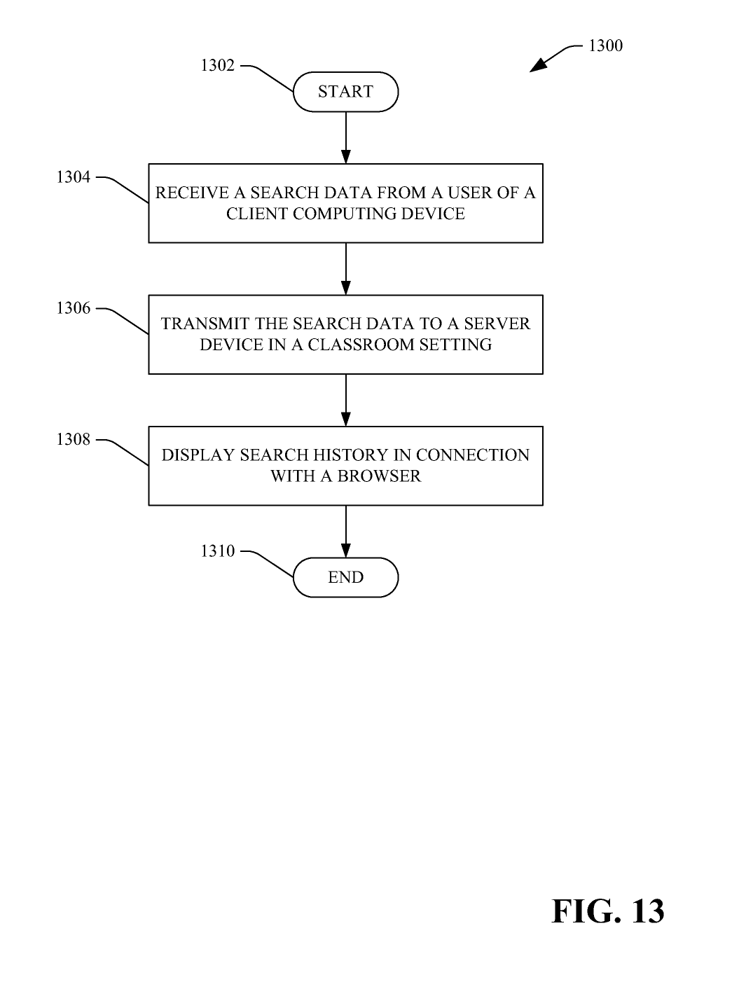

With reference now to FIGS. 12-13, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 12, an example methodology 1200 that facilitates causing search data of a student to be displayed on a display screen of a computing device is illustrated. The methodology 1200 begins at 1202, and at 1204 search data is received at a first computing device from a plurality of interconnected computing devices. For instance, the plurality of interconnected computing devices may be utilized by a plurality of students and a teacher and/or teachers. The search data received from the plurality of computing devices can include queries issued by students through use of search engines, domains visited by users upon executing a search through use of a search engine, websites visited by students upon executing a search via a search engine, an amount of time spent by students on certain websites, data that has been extracted from websites, etc. It is to be understood that the search data is independent of a search engine utilized by the student to obtain information.

At 1206, the search data received at 1204 is caused to be displayed on a display screen that is in communication with a server computer. The server computer can be operated by a teacher who can review the search data to ascertain how students are performing a particular search task. The methodology 1200 completes at 1208.

Referring now to FIG. 13, an example methodology 1300 that facilitates displaying data on a computer of a student is illustrated. The methodology 1300 starts 1302, and at 1304 search data is received from a user of a client computing device. For instance, the search data may be a query, a website selected by a student, etc. At 1306, the search data is transmitted to a server device in a classroom setting. At 1308, search history is displayed in connection with a browser on the client computing device. The search history may include queries issued by the student, websites visited by the student, etc. The methodology 1300 completes at 1310.

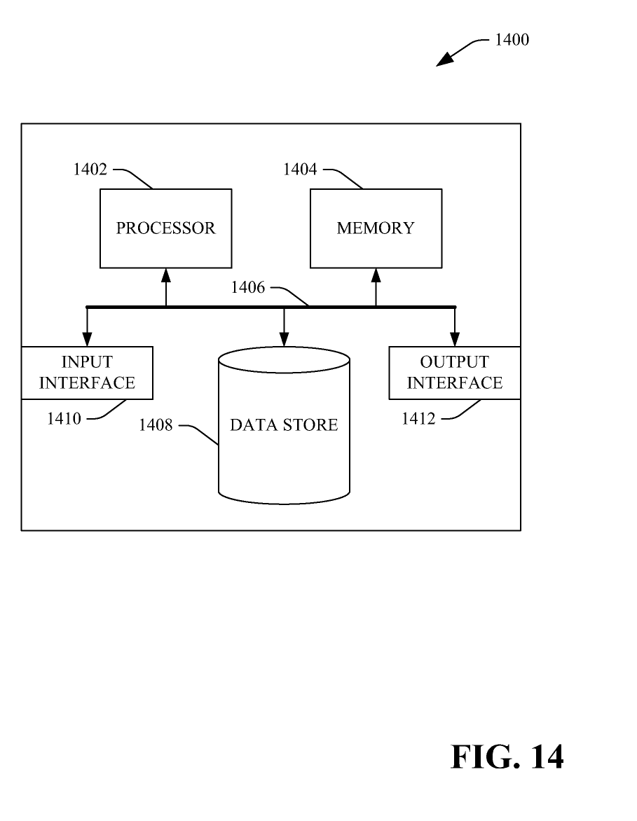

Now referring to FIG. 14, a high-level illustration of an example computing device 1400 that can be used in accordance with the systems and methodologies disclosed herein is illustrated. For instance, the computing device 1400 may be used in a system that supports instructing students to perform search tasks in a classroom setting. In another example, at least a portion of the computing device 1400 may be used in a system that supports displaying search task information to a teacher and/or students. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store graphical user interfaces, search data including queries or websites, etc.

The computing device 1400 additionally includes a data store 1408 that is accessible by the processor 1402 by way of the system bus 1406. The data store 1408 may include executable instructions, images, search data, a list of students in a class, etc. The computing device 1400 also includes an input interface 1410 that allows external devices to communicate with the computing device 1400. For instance, the input interface 1410 may be used to receive instructions from an external computer device, from a user, etc. The computing device 1400 also includes an output interface 1412 that interfaces the computing device 1400 with one or more external devices. For example, the computing device 1400 may display text, images, etc. by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass hardware, software, or a combination of hardware and software. Thus, for example, a system or component may be a process, a process executing on a processor, or a processor. In another example, a component may be a certain portion of memory, a series of transistors in a processor, an integrated circuit, etc. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving, at a first computer, search data from each of a plurality of interconnected client computing devices, wherein the search data comprises one or more search terms provided to one or more search engines by users of the client computing devices, wherein the search data is independent of the search engines utilized by the users of the client computing device; and
causing the search data to be displayed on a display that is in communication with the first computer.

2. The method of claim 1, wherein the search data further comprises at least one search result provided to a user of a client computing device by a search engine utilized by the user of the client computing device.

3. The method of claim 1, wherein the search data further comprises at least one search result selected by a user of a client computing device, wherein the search result is provided by a search engine responsive to receipt of a query from the user.

4. The method of claim 1, further comprising causing a list of names corresponding to the client computing devices to be displayed together with the search data.

5. The method of claim 1, wherein causing the search data to be displayed comprises causing queries to be displayed on the display, wherein format of a displayed query is based at least in part upon a number of times that users of the client computer devices entered the query into a search engine.

6. The method of claim 5, further comprising:
receiving a selection of a query displayed on the display; and
responsive to receipt of the selection, causing one or more of:
a) identities of users of the client computing devices that issued the query to be displayed on the display; or
b) identities of websites visited by users of the client computing devices that issued the query to be displayed on the display.

7. The method of claim 1, further comprising transmitting data that blocks activity of a browser executing on at least one computer in the plurality of interconnected computers.

8. The method of claim 1, wherein the search data further comprises search results retrieved by the users of the client computing devices by way of issuing queries to the search engines, and wherein causing the search data to be displayed comprises:
causing domain names corresponding to the search results to be displayed on the display, wherein format of a displayed domain name is based at least in part upon a number of times that users of the client computing device selected search results corresponding to the domain name.

9. The method of claim 8, further comprising:
receiving a selection of the domain name displayed on the display from the user of the first computer; and
responsive to receipt of the selection, causing one or more of:
a) identities of users of the client computing devices that selected the search results corresponding to the domain name to be displayed on the display; or
b) identities of websites corresponding to the domain name visited by users of the client computing devices to be displayed on the display.

10. The method of claim 1, wherein the search data further comprises search results retrieved by the users of the client computing devices by way of issuing queries to the search engines, and wherein causing the search data to be displayed comprises:
causing domain names corresponding to the search results to be displayed on the display in a list format.

11. The method of claim 10, further comprising:
causing websites corresponding to the domain names that were selected by the users to be displayed in connection with their corresponding domain names in a tree structure.

12. The method of claim 1, further comprising:
causing a list of names of users of the client computing devices to be displayed together with the search data.

13. The method of claim 12, further comprising causing a web browser to be displayed together with the list of names and the search data, wherein the web browser is directable to web pages by the user of the first computer.

14. A system that facilitates teaching users search engine techniques, the system comprising:
a receiver component that receives search data from a plurality of interconnected client computers, wherein the search data comprises queries provided to a plurality of search engines by users of the plurality of client computing devices, wherein the search data is independent of the search engines employed by the users of the plurality of client computing devices to perform a search; and
a display component that causes the search data to be displayed on a display that is in operable connection with a server computing device that comprises the receiver component.

15. The system of claim 14, wherein the search data further comprises websites visited by the users of the client computing devices in connection with one or more searches performed via one or more of the search engines.

16. The system of claim 15, further comprising a selection component that receives a selection of a subset of the search data displayed on the display by a user of the server computing device, wherein selection of the subset of the search data causes additional data pertaining to the selected subset of the search data to be displayed on the display.

17. The system of claim 16, wherein the additional data is an identity of at least one user of a client computing device that corresponds to the subset of the search data.

18. The system of claim 16, wherein formats of portions of the search data are based at least in part upon popularity of queries, query terms, or websites visited.

19. The system of claim 17, wherein the display component updates the search data in real-time as additional search data is received from the client computing devices.

20. A computer-readable medium comprising instructions that, when executed by a processor, cause the processor to perform acts comprising:
receiving, at a server computing device, search data from a plurality of interconnected client computing devices, wherein the client computing devices are operated by students assigned a search task by a teacher that is utilizing the server computing device, wherein the search data comprises:
a) search terms issued by the students to a plurality of search engines pertaining to the search task; and
b) websites selected by the students from search results provided by the plurality of search engines responsive to receipt of the search terms; and
displaying on a display that is in communication with the server computing device a list of identities of the students utilizing the client computing devices together with the search data.
